(19) United States
(12) Patent Application Publication
(10) Pub. No.: US 2015/0050976 A1
(43) Pub. Date: Feb. 19, 2015

(54) System and Method for Facilitating the Operation of a Combined Lottery/Bonus Game with Rewards

(71) Applicant: GTECH Corporation, Providence, RI (US)

(72) Inventor: Amy Morin, North Providence, RI (US)

(73) Assignee: GTECH Corporation, Providence, RI (US)

(21) Appl. No.: 14/107,451

(22) Filed: Dec. 16, 2013

Related U.S. Application Data
(60) Provisional application No. 61/866,183, filed on Aug. 15, 2013.

(51) Int. Cl. G07F 17/32

(52) U.S. Cl. CPC G07F 17/329
USPC 463/17

(57) ABSTRACT

Systems and methods for facilitating the operation of an instant win lottery game where a bonus indicator provides eligibility for a bonus are disclosed. The holder of an instant win ticket with a bonus indicator can redeem the ticket and receive a bonus including at least one of loyalty points for accumulation and/or redemption, access to one or more bonus games for an opportunity to earn points for accumulation and/or redemption and others.

### BACKGROUND

Lottery games of both the “instant win” and “future draw” type games are popular. They are found in state run and privately run lottery systems worldwide, and provide a significant source of income for government operators to generate revenues for public purposes such as education.

Future draw lotteries, like Lotto or Powerball often have large prizes and appeal to players who purchase tickets on a regular schedule or with a group. However, these games, which often have daily or weekly draws, often do not appeal as much to players who want immediate entertainment and the chance for a win at the present time. However, future draw games with particularly large “life changing” jackpots often attract players who would not otherwise play the game, increasing returns for the game operators.

Instant win tickets are most commonly sold as “scratch-off” tickets, where the game result is indicated by game play information concealed by a removable scratch-off layer. This layer can be removed by the player after the ticket is purchased to reveal the game outcome. Instant win tickets are popular in part because they allow a player to determine the prize value of their ticket immediately after purchase. Instant win tickets also have bright, attractive graphic schemes and are sold as eye-catching consumer items. One approach to increasing instant win ticket sales that has been used successfully is to offer games that include a small likelihood of a large “life-changing” prize. These prizes may attract players who might not otherwise play the game, or cause regular players to purchase additional tickets.

However, generally there are only a limited number of large prizes in a particular instant ticket game with a finite number of issued tickets. Sometimes there may be only a single very large grand prize for a game. In some jurisdictions where large prize tickets are sold, the lottery may be required to pull or discontinue the game when the large prize is redeemed. The probability of having a particular level of ticket sales that occur before a redemption of a large prize can be statistically predicted. Game operators can then adjust the prize structure and payout percentage to ensure the proper expected return for the lottery in light of the possibility of an early game termination. However, there is still a great deal of unnecessary expense incurred when an early redemption of the large prize ticket occurs.

To provide additional user interest, some game operators have provided drawings or additional play options for losing instant tickets, e.g., all players holding losing tickets could use a form to mail in losing tickets to be entered in a consolation drawing. One purpose of such drawings is to allow game operators to build up customer information databases for purchasers who would otherwise remain anonymous. However, such “second chance” games cannot provide any additional reward to holders of winning tickets because almost all instant lottery games require that winning tickets be tendered for redemption in order to receive the associated instant ticket prize. Thus holders of winning tickets, even for small prizes, could not be entered in a second chance mail-in drawing.

In various aspects, the present invention provides additional user interest to players of physical ticket games through a bonus game and/or bonus loyalty program offering, whereby, for example, a game ticket is provided with a known and/or an unknown bonus value to the player. In specific embodiments, the known value can be a known amount of loyalty points, and the unknown value can be an unknown amount of loyalty points. In various embodiments of the present invention, the unknown value becomes a known value after the player accesses an electronic portal (e.g., web site), enters a code or some type of indicia that may be found on the ticket, for example, and plays a bonus game to reveal the previously unknown value. In various embodiments of the present invention, the bonus game involves a pre-determined award to the player, such that there is no skill or selection required by the player in order to determine the bonus award. In other embodiments of the present invention, the player can select from among multiple game or reveal offerings using the electronic portal, such that the bonus game revealing feature does not begin until the player makes a selection.

### BRIEF DESCRIPTION OF THE DRAWINGS

FIG. 1 is an illustration of an example system, according to one example embodiment of the present invention.

FIG. 2 is an exemplary embodiment of a lottery ticket in accordance with the present invention.

### DETAILED DESCRIPTION OF EXAMPLE EMBODIMENTS

Some example embodiments according to the present invention include systems, methods and tickets for use in operating combined instant ticket/bonus games. These instant ticket games may provide conventional instant win cash prizes. In addition, some of the tickets in the game may also award a bonus such as loyalty points and/or a bonus game that is to be played at a later time. The instant tickets can award the bonus on the basis of a special symbol or combination of symbols indicating that the ticket holder has won the bonus. The bonus can be presented for redemption, after which one or more of several actions can take place. For example, upon presentment of the bonus, a points award can be added to a loyalty rewards account balance, and/or one or more bonus games can be presented to the player giving the player the chance to win additional bonus points. Bonus points can be accrued in a player account and redeemed towards different prizes over time. In one embodiment of the present invention, a player can present the special symbol(s) indicative of the bonus electronically, such as through an Internet web site. Further, a player can receive a bonus electronically and the player's account can be initiated, updated, maintained and stored electronically.

Players who win bonus points may have a more interesting “extended play” game experience, and more players may feel they came closer to winning a big prize, resulting in greater player interest.

One example embodiment of the present invention is a method for the play of an instant win lottery game where one or more customers are provided instant win lottery tickets.

The tickets include game play information. A first set of the tickets will have game play information which indicates the ticket is a winner of a cash (or cash equivalent) prize. A second set of the tickets will have a bonus indicator, indicating the holder of the ticket is eligible for a bonus. A third set of the tickets will indicate both types of prizes, instant cash and bonus. When a ticket indicating eligibility for a bonus is redeemed, the holder of the ticket can receive one or more different bonus elements as exemplified herein. In one embodiment of the present invention, a fourth set of tickets will not indicate eligibility for either prize.

When a player (e.g., customer) presents a ticket of the first or third set of tickets, the player may be given the appropriate cash prize for winning the instant ticket game.

When a player (e.g., a customer who has purchased a ticket) presents a ticket of the second or third set of tickets, the player may be given a bonus opportunity such as, for example, one or more bonus and/or loyalty points, or credentials to play a bonus game using a computing device.

Optionally, tickets may include unique human readable identification information thereon. Such information can be used to identify the ticket and further to provide access to an electronic system for revealing the outcome of a bonus opportunity.

Some other example embodiments in accordance with the present invention include a system for facilitating the operation of a game of chance that includes a plurality of pre-printed instant win lottery tickets with removable covers. Each of the lottery tickets will have game play information under the removable cover. A first set of tickets, where a set is a subset of the plurality, will have game play information which indicates the ticket is a winner of a cash (or cash equivalent) prize. A second set of tickets will have a bonus indicator indicating the holder of the instant ticket is eligible for a bonus, such as an exact number or a range of a number of loyalty points associated with the ticket, where the loyalty points can be used to start a loyalty account, or add to points in a pre-existing loyalty account, for example. Optionally, the bonus indicator can be a code, symbol or combination thereof that a player can use to add bonus points to a player loyalty account. Optionally, the bonus indicator can be an exact number of loyalty points plus a code, symbol or combination thereof for use in adding the exact number of loyalty points to a loyalty account points balance. Optionally, the bonus indicator can be a plurality of codes, symbols or combinations thereof, wherein at least one of the codes can be used by a player to add a number of loyalty points to a player account balance and at least one other of the codes can be used by a player to play a bonus game giving the player the opportunity to earn an additional bonus, wherein the additional bonus can be a lottery ticket, loyalty points, a prize, a raffle entry or other bonus, including additional games, for example.

In one embodiment of the present invention, a plurality of terminals can be configured to receive the instant lottery tickets in the first set of tickets for redemption. Optionally, the terminals may be retail, hand-held or self-serve automated terminals, or may be terminals staffed by an agent. The terminals may redeem the first set of lottery tickets for cash prizes. The terminals may also redeem the second set of lottery tickets. The terminals can also be used to enter bonus indicators. In one embodiment of the present invention, the bonus indicators are used to add points to a points account electronically, such as through a host/web site, for example. In another embodiment of the present invention, the bonus indicators are used to play games electronically, such as through a host/web site, for example, wherein the games provide a chance to earn additional points for a points account. In another embodiment of the present invention, the player can redeem earned points for prizes electronically, such as through a host/web site, for example.

There may also be a third set of tickets which have the prizes of both the first and second set described above. There may also be a fourth set of tickets which have the prizes of neither the first nor second set. The example embodiment may also have a host which is in network communication with the terminals. The host can provide redemption information, prize information, bonus information and ticket information to the terminals as appropriate. The host can further host bonus games, generate random seeds to be used in bonus games to manage game outcomes, host player account data, including player loyalty points balances, and otherwise manage player interactions with the present invention. It will be appreciated that the terminals can be any of a variety of terminals, including stand-up kiosks in gaming locations, private computers, such as desktop personal computers, laptops, and mobile communications devices, including smartphones, tablet computers and other devices having computing and processing power and capable of communicating with the host over a network.

The host can log and store relevant data such as entrant data, sales data, ticket to information, ticket redemption information, winner data, and assorted other relevant data may be logged and used by example embodiments of the present invention.

Optionally, the terminals, host, and tickets are designed with verification, validation, and/or anti-cheating mechanisms to ensure game integrity.

Example embodiments include a plurality of tickets with game play information on a first layer of the ticket. The tickets can optionally be provided with a second opaque layer which can be removed by a player (e.g., purchaser of the ticket) to reveal an indication of some prize. Game play information can indicate an “instant prize” of known value, such as for example, cash, credits, a free ticket, etc. Alternatively, game play information can indicate eligibility for a bonus/prize, such as for example, loyalty points to be accumulated for a prize (e.g., ten loyalty points, where a prize requires redemption of fifteen points), loyalty points sufficient for a prize (e.g., fifteen loyalty points, where a prize requires the same fifteen points be redeemed), one or more bonus game plays, or a free future draw raffle ticket, which would have unknown value until the future draw determined if the raffle ticket was a winner. The example embodiment ticket may have a special bonus/prize eligibility indicator separate from the above-mentioned game play information. It will be appreciated that a bonus and/or prize can be used interchangeably in the specification, and can refer to a specific, tangible award, such as a free ticket or cash, and can further refer to a less tangible award, such as points, or a game play for a chance to win a prize or points, for example.

Optionally, the example embodiment may have a computer readable code (e.g., barcode) and/or human readable code. This code can be used to validate the ticket, or for a machine to read the contents of the ticket. The example embodiment can also include security and/or anti-tampering technologies.

Example embodiments of the present invention can include a method for facilitating play of a game of chance, which includes providing a plurality of instant win lottery tickets for at least one instant ticket game, where all of the instant win lottery tickets include game play information for at least one instant ticket game. There may be at least a first subset of the instant lottery tickets having game play information that indicates the ticket is a winner of a prize in the respective instant lottery game, and at least a second subset of the instant lottery tickets having at least one symbol indicating the instant ticket is eligible for a bonus, as described above, for example. Optionally, the eligibility indicator can be contained in the game play information. Optionally, the game play information can include second game play information indicating eligibility for a bonus in the form of at least one point for accumulation and redemption via an online player account. Optionally, the game play information can include third game play information on at least the second subset of the plurality of tickets indicating eligibility for at least one bonus game for an opportunity for a player to earn additional points for accumulation and redemption. Optionally, the second game play information and the third game play information comprise different indicia. In one embodiment of the present invention, the second game play information and the third game play information comprise the same indicia.

A method according to embodiments of the present invention can, responsive to receiving an instant win lottery ticket from the first subset that has been tendered for a prize, redeem the lottery ticket for the prize indicated by the game play information on the lottery ticket. Such a method can repeat the redeeming for other ticket holders with lottery tickets in the first subset. Optionally, the method can, responsive to receiving a lottery ticket from the second subset that has been tendered for bonus points, add an exact number or a range of a number of loyalty points associated with the ticket to a new or pre-existing loyalty account. Optionally, the bonus indicator can be a code, symbol or combination thereof that a player can use to add bonus points to a player loyalty account. Optionally, the bonus indicator can be an exact number of loyalty points plus a code, symbol or combination thereof for use in adding the exact number of loyalty points to a loyalty account points balance. Optionally, the bonus indicator can be a plurality of codes, symbols or combinations thereof, wherein at least one of the codes can be used by a player to add a number of loyalty points to a player account balance and at least one other of the codes can be used by a player to play a bonus game giving the player the opportunity to earn an additional bonus, wherein the additional bonus can be a lottery ticket, loyalty points, a prize, a raffle entry or other bonus, including additional games, for example.

Optionally, some of the tickets can be of both the first and second subsets. Optionally, the method can generate a record for each bonus provided. Optionally, the method can store the records in a database or file.

Example embodiments of the present invention can include a system for facilitating the operation of a game of chance, including a plurality of pre-printed instant win lottery tickets with removable covers, where each of the lottery tickets have game play information under the removable covers. The tickets include a first subset of the instant lottery tickets having game play information that indicates to the holder of the ticket the ticket is a winner of a cash prize in the instant lottery game, and at least a second subset of the instant lottery tickets having at least one symbol indicating the holder of the instant ticket is eligible for a bonus. Optionally, the indicator can be in the game play information. Optionally, there can be a fourth set of tickets which indicate no prize.

The system of the present invention can, in various embodiments, include a plurality of terminals configured to receive the instant lottery tickets in the first subset for redemption. Optionally, the terminals may be retail, hand-held or self-serve automated terminals, or may be terminals staffed by an agent. The terminals can be configured to redeem the first set of lottery tickets for cash prizes. The terminals can be configured to receive entries of bonus indicators. In one embodiment of the present invention, the bonus indicators are used to add points to a points account electronically, such as through a host/web site, for example. In another embodiment of the present invention, the bonus indicators are used to play games electronically, such as through a host/web site, for example, wherein the games provide a chance to earn additional points for a points account. In another embodiment of the present invention, the player can redeem earned points for prizes electronically, such as through a host/web site, for example.

The system can include a host in networked communication with the plurality of terminals. The host can be configured, responsive to the tender of a lottery ticket in the first subset for redemption at a terminal, to transmit an indication to the terminal that the ticket should be redeemed for an instant win prize. The host can be further configured, responsive to the tender of a bonus indicator, to process the bonus indicator as described in embodiments above.

The system can optionally include a randomization device, configured to select at least one of a group of generated raffle tickets as a winner, and/or to execute games having random outcomes.

The system can optionally include a database in communication with the host, the database configured to store information regarding bonuses and prizes, including, for example, bonus points in player accounts.

Optionally, the terminals can be configured to receive and/or read unique human readable identification information on each of the lottery tickets. Also the database can be configured to store the human readable identification information from the tickets.

Example embodiments of the present invention can include a host for a system for facilitating the play of a game of chance. The host can have a network interface configured to provide networked communication with a plurality of lottery ticket terminals. The host can have an instant ticket redemption control module in communication with the network interface. The redemption control module can be configured to facilitate the redeeming of instant win lottery tickets when appropriate. The host can have a bonus generation module configured to generate bonus items upon receiving an indication that a player has entered a bonus indicator into a terminal. The host can have a bonus game generation module configured to generate bonus games upon receiving an indication that a player has entered a bonus indicator into a terminal. The host can have a database in communication with the bonus generation module, wherein the database is configured to log data and store records related to bonus items. The host can include a randomization module in communication with the database, the randomization module configured to generate bonus game outcomes.

Example embodiments of the system of the present invention for facilitating the operation of a game of chance include a plurality of pre-printed instant tickets displaying game play information beneath removable covering. The system can have a first subset of the plurality of pre-printed instant tickets where the game play information includes an indication that the pre-printed instant ticket is an instant winner of a prize. In one example embodiment, the system can have a second subset of the plurality of pre-printed instant tickets where the game play information comprises a bonus indicator. The system can have a third subset of the plurality of pre-printed instant tickets where the game play information comprises the indication that the instant ticket is an instant winner of an instant prize in a prize structure and further comprises the bonus indicator.

In one example embodiment, a computer readable medium comprises computer readable instructions to perform the methods for facilitating play of a game of chance in accordance with the present invention.

In one alternative example, and whether or not the ticket is presented for redemption of any prize associated with the game on the ticket, the ticket itself includes play information indicating whether the ticket is eligible for a bonus. For example, the bonus can be in the form of bonus points identified on the ticket, wherein the bonus points can be awarded and attributed to a player. In one embodiment of the present invention, the bonus points are a certain sum of points and are not undetermined, such as a range of points that can be determined separate from the ticket itself (e.g., by accessing a computer system). In one embodiment of the present invention, the ticket includes a bonus indicator code, which allows a user to associate the determined bonus points with a player account. The user is thus eligible for one or more bonus points shown on the ticket, but the user does not earn the one or more points until they are associated with a player account.

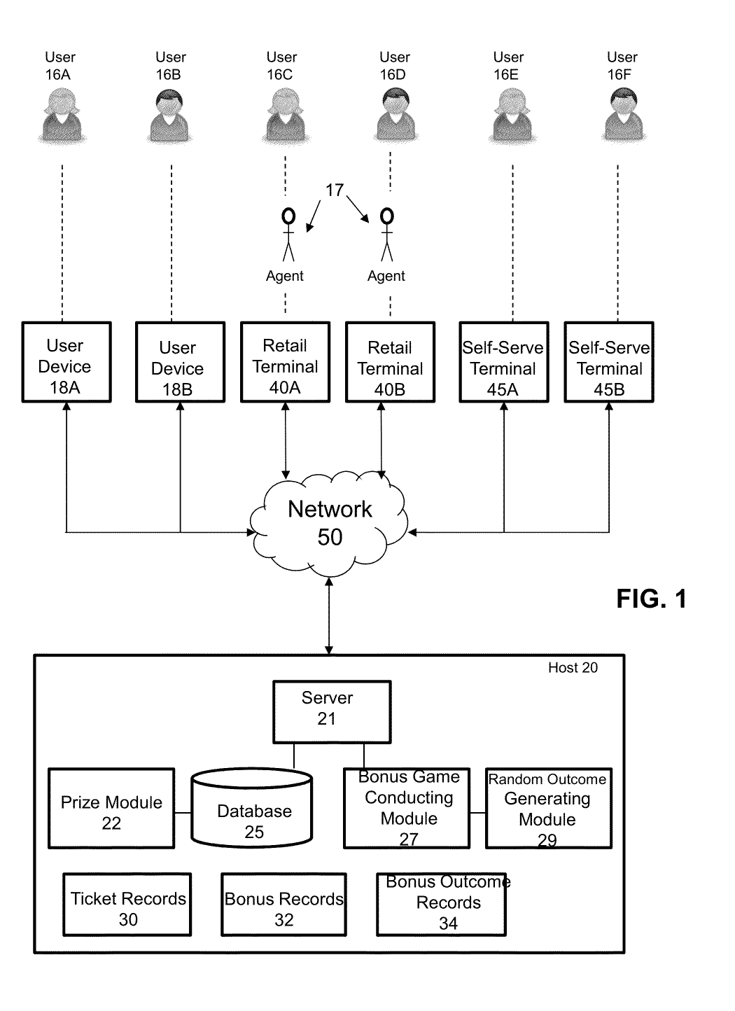

FIG. 1 is an illustration of an example system, according to one example embodiment. In this example system there is a Host 20, which contains a Server 21. Server 21 can be a single central server, a plurality of distributed servers, or any other example embodiment capable of facilitating the operations and components of Host 20. The Server 21 can have and/or communicate with a database 25 to facilitate operation of the server and to facilitate necessary and desired logging of system events. The database 25 can be used to store the identification and/or contact information of players, and can further be used to store player account information, bonus games, available prize information and computer programs for operating in accordance with the present invention as described herein. The database 25 can log sales, issued numbers, draw dates for any associated drawings, or any other information relevant to the system operator. The database 25 can store information such as what instant prizes are associated with what identifying information associated with a ticket and transmitted to the Server 21 (e.g., a barcode on the ticket transmitted to the Server 21 which looks up what prizes that are associated with that ticket). The database 25 can store Instant Ticket Records 30, Bonus Ticket Records 32, and Bonus Outcome Records 34. There can be an Instant Prize Module 22 responsible for facilitating the awarding and verifying of instant prizes. There can be a Bonus Conducting Module 27 responsible for facilitating the issuing and generating of bonus values and the conducting of the bonus games upon a game initiating condition. The Bonus Conducting Module 27 can have a Random Outcome Generating Module 29, responsible for selecting one or more raffle winners at random, or one or more winning raffle tickets at random. The Random Outcome Generating Module 29 can further be used to determine outcomes of any bonus games played, wherein the outcomes can be, for example, a randomly determined amount of additional bonus points for a player of a bonus game. This module 29 can further be used to randomly determine which game, from among a number of bonus games, is presented to a player, in various embodiments of the present invention.

The Host 20 can be connected to a Network 50 (e.g., the Internet) to a plurality of Self-serve terminals 45A, 45B, etc. These terminals can allow a User 16E, 16F, etc. to purchase an instant win ticket at the terminal, and/or to enter a bonus eligibility indicator as read from a ticket. In one aspect, the customer may be forced by game policy to redeem the ticket at a non-self-serve location. Alternatively, the Self-serve terminals 45A, 45B can be configured to redeem prizes and issue raffle tickets when appropriate. If this example embodiment is used, the tickets sold will preferably have a tamper proof/resistant identification system so that Server 21 knows what instant win prizes and how many raffle tickets to issue to the customer at that Self-serve terminal 45A, 45B, etc. Alternatively, Self-serve terminals 45A, 45B can be limited to “virtual instant win tickets” where the self-serve terminal 45A, 45B has a video display and issues the customer an instant win ticket without actually giving the customer a physical ticket which might have been tampered with. In this way, a self-serve terminal can be configured to dispense both physical tickets and “virtual tickets” but may be limited to only redeeming virtual tickets. The virtual tickets can operate exactly like the physical tickets, and can even represent physical tickets located in the Self-serve terminal 45A, 45B or another device in communication with the Host 20 or Self-serve terminal 45A, 45B, but differ in that the customer is never given physical control over the ticket prior to redemption. The Self-serve terminal 45A, 45B can also be limited to small prize redemptions, and customers with large wins may need to visit a non-self-serve terminal for verification and redemption.

The Host 20 can be connected via a Network 50 (e.g., the Internet) to a plurality of Retail locations 40A, 40B, etc., or “non-self-serve” locations. One example of these may be a retail sales point at a convenience store or gas station where a human attendant may sell the tickets and/or redeem tickets. The Retail terminals 40A, 40B, in connection with the Host 20, can be configured to generate for and issue to a customer a game ticket. The Retail terminal 40A, 40B, etc. can be configured to require operation by an Agent 17 to sell tickets to Users 16C, 16D, etc. and redeem tickets for Users 16C, 16D, etc.

Host 20 can be connected via Network 50 (e.g., the Internet) to a plurality of User Devices 18A, 18B, etc. These can, for example, be cell phones, smartphones, PDAs, notebook computers, or personal computers. The User 360 can use the User Device 340 to purchase instant lottery tickets in a similar fashion as the Self-serve terminals 45A, 45B, and further to enter any code or codes contained on the ticket for the purposes described above. Since Self-serve terminal 45A, 45B may be loaded with printed tickets or have a proprietary printing system, the User Device 340 may differ in this respect, and may be limited to virtual tickets, in one embodiment of the present invention.

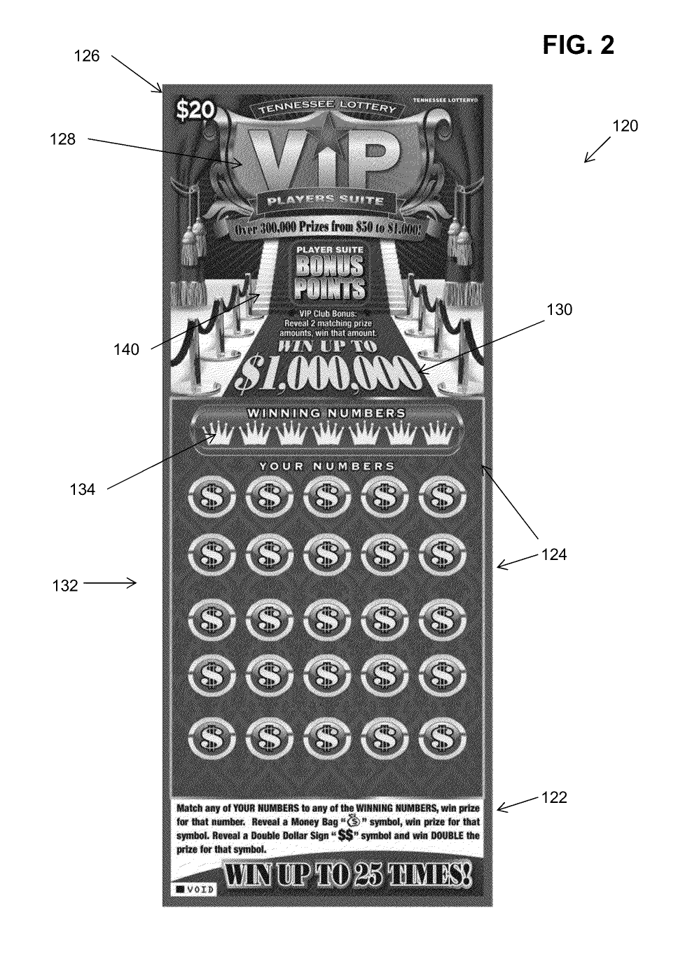

FIG. 2 shows an example instant win scratch off ticket 120 in accordance with one embodiment of the present invention. Region 122 includes instructions on how to play the game printed on the ticket substrate. These instructions include information indicating how to determine what prize, if any, the example ticket qualifies for. Region 124 contains a removable cover, for example, a conventional latex cover a player may scratch off to reveal a layer underneath. The ticket also may include information 126 that indicates the cost of the ticket. The ticket indicates the name 128 of the instant win lottery game, and also includes information 130 indicating one of the prizes available in the game, preferably the top prize available to any player of the ticket.

If any of the numbers from the twenty-five numbers in the “YOUR NUMBERS” region 132 match any of the numbers in the “WINNING NUMBERS” region 134, the ticket will be redeemable for the amount indicated under the number.

FIG. 2 also illustrates an indication of an area 140 for a bonus eligibility indicator. In this example ticket, the bonus eligibility indicator is in addition to the instant win prize. In one embodiment of the present invention, the bonus eligibility indicator is game play information underneath a covering that can be scratched off. In scratching off the covering material in area 140, a player can reveal one or more items, including: an indication of at least one “instantly won” point for accumulation and redemption via an online player account, an indication of eligibility for at least one bonus game for an opportunity for the player to earn additional points for accumulation and redemption, a code/indicia through which the player can apply the instantly won point or points to a player account via a computer host (e.g., through a web site), a code/indicia through which the player can access and play one or more bonus games as described, a web site location (e.g., uniform resource locator (URL)) through which the code/indicia can be entered.

In one embodiment of the present invention, the code/indicia for applying the instantly won point or points and the code/indicia for allowing the player to access and play a bonus game are different codes. In another embodiment of the present invention, the code/indicia for applying the instantly won point or points and the code/indicia for allowing the player to access and play a bonus game is a single unitary code. In embodiments of the present invention, the single input of the code by the player results in the player's account being credited in the amount of any instantly won points while also resulting in the player being presented with: one or more randomly determined points; a bonus game to reveal one or more additional points; a bonus game menu to select a game which, when played, reveals one or more additional points. The bonus game can thus be retrieved by the computer system of the present invention without any further input from the player. The player may provide additional input in the form of selecting a bonus game, or in playing a bonus game, but such additional input may further not be required in order to reveal the result of the bonus game to the player. In one embodiment of the present invention, the code is an alphanumeric code that can be read by a player and entered into a terminal (e.g., home computer, mobile communications device, etc.) using a physical or virtual keyboard or other conventional data entry methods. Thus, when, for example, the player accesses the host via a web site and enters the code and appropriate player identification information, the player's account can be accessed by the host, the instantly won point or points can be applied to the player's account, and one or more bonus games can be presented to the player for the opportunity to win additional bonus points. The present invention can provide different codes for these purposes in the event a player simply wants to apply instantly won points but not play a game, for example. In one embodiment of the present invention, when the player is provided with a bonus game, the one or more additional points available through the game will always be sufficient for the player to win a prize. In this way, the player is incentivized to access the host, input the code, associate the code with the player account and play the bonus game. A lottery operator may desire such behavior in order to better track game play and player behavior for business purposes.

It will be appreciated that the one or more bonus points made available through the one or more bonus games can be independently sufficient to win a prize, or only sufficient when added to some or all of previously accumulated points in the player's account. For example, the present invention can operate such that a bonus game yields fifteen bonus points to the player, and the fifteen points are sufficient to win a low tier catalog prize. Alternatively, the present invention can operate such that a bonus game yields fifteen bonus points to the player, and the system of the present invention identifies that the player account already holds two hundred bonus points, upon which the system can then offer the player the opportunity to redeem two hundred and fifteen points for a particular prize. In this way, the bonus eligibility indicator included in the game play information on the ticket can indicate whether the player has effectively won eligibility for a prize associated with the game that is separate from the primary prize on the ticket itself.

In one embodiment of the present invention, the player can select from one or more bonus games for play as may be presented in a menu by the host, for example. In another embodiment of the present invention, the host can automatically and/or randomly determine the bonus game to be offered to the player. In one embodiment of the present invention, no points are awarded unless and until the code(s) is associated with a specific player's account, such as by having a player provide player identification information to the host.

It will be appreciated that the host is configured to receive the game play information, which may be in the form of a code/indicia as described above, and player identification information, determine a player account associated with the player identification information, store and retrieve at least one bonus game, determine an outcome associated with the at least one bonus game, present the at least one bonus game to a player, wherein the at least one bonus game provides the player with an opportunity to earn one or more additional bonus points according to the determined outcome, and apply the one or more additional bonus points to the determined player account. In one embodiment of the present invention, the host is further configured to access a database of available prizes and present options to the player for redeeming player account points for one or more available prizes.

It will be appreciated that one aspect of the present invention thus provides access to a computer system for one or more players to submit the unique bonus indicator code from at least one ticket for association with a player account. The computer system further can apply a certain value of “instantly won” bonus points to the player account, wherein the certain value is printed on the ticket. The computer system further can store and retrieve at least one bonus game, determine an outcome associated with the one bonus game, present the bonus game to the player, wherein the bonus game provides the player with an opportunity to earn one or more additional bonus points according to the determined outcome, and apply the bonus point(s) to the player account. In providing access to the computer system, the present invention can, for example, provide a web site accessible via a network such as the Internet through which the one or more players can access the computer system and provide the unique bonus indicator code from the at ticket.

It will be appreciated that all of the disclosed methods, games, and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor which, when executing the series of computer instructions, performs or facilitates the performance of all or part of the disclosed methods, games, and procedures.

Unless otherwise stated, devices or components of the present invention that are in communication with each other do not need to be in continuous communication with each other. Further, devices or components in communication with other devices or components can communicate directly or indirectly through one or more intermediate devices, components or other intermediaries. Further, descriptions of embodiments of the present invention herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media. At a minimum, the memory includes at least one set of instructions that is either permanently or temporarily stored. The processor executes the instructions that are stored in order to process data. The set of instructions can include various instructions that perform a particular task or tasks. Such a set of instructions for performing a particular task can be characterized as a program, software program, software, engine, module, component, mechanism, or tool. Common forms of computer-readable media that may be used in the performance of the present invention include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions associated with the present invention to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, EDGE and EVDO. Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art. Appropriate encryption and other security methodologies can also be employed by the system of the present invention, as will be understood to one of ordinary skill in the art.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

1. A system for facilitating the operation of a game of chance, comprising:
a plurality of tickets with game play information;
first game play information on at least a first subset of the plurality of tickets indicating an instant prize of known value; and
second game play information on at least a second subset of the plurality of tickets indicating eligibility for a bonus in the form of at least one point for accumulation and redemption via an online player account.

2. The system of claim 1, further including third game play information on at least the second subset of the plurality of tickets indicating eligibility for at least one bonus game for an opportunity for a player to earn additional points for accumulation and redemption.

3. The system of claim 2 wherein the second game play information and the third game play information comprise different indicia.

4. The system of claim 3 wherein the second game play information and the third game play information comprise the same indicia.

5. The system of claim 1 wherein the eligibility for at least one point is specified as an exact number and not a range of numbers on the second subset of the plurality of tickets.

6. The system of claim 1 wherein the at least one point is awarded once the second game play information is associated with the online player account.

7. The system of claim 2 wherein the at least one bonus game is presented to a player once the third game play information is associated with the online player account.

8. The system of claim 1, further including a host configured to receive the second game play information and player identification information, determine a player account associated with the player identification information and apply the at least one point to the determined player account.

9. The system of claim 2, further including a host configured to receive the third game play information and player identification information, determine a player account associated with the player identification information, store and retrieve at least one bonus game, determine an outcome associated with the at least one bonus game, present the at least one bonus game to a player, wherein the at least one bonus game provides the player with an opportunity to earn one or more additional bonus points according to the determined outcome, and apply the one or more additional bonus points to the determined player account.

10. The system of claim 1 wherein the additional points have a minimum value that is associated with a known prize.

11. A computer-implemented method for providing additional game plays to players of a lottery game, comprising the steps of:
producing tickets for the lottery game, including printing a unique bonus indicator code on each ticket;
providing access to a computer system for one or more players to submit the unique bonus indicator code from at least one ticket for association with a player account;
the computer system applying a certain value of bonus points to the player account, wherein the certain value is printed on the at least one ticket, and the computer system further storing and retrieving at least one bonus game, determining an outcome associated with the at least one bonus game, presenting the at least one bonus game to the one or more players, wherein the at least one bonus game provides the one or more players with an opportunity to earn one or more additional bonus points according to the determined outcome, and applying the one or more additional bonus points to the player account.

12. The method of claim 11 wherein the step of providing access to a computer system comprises providing a web site accessible via a network through which the one or more players can access the computer system and provide the unique bonus indicator code from the at least one ticket.

13. The method of claim 11 wherein the tickets include a first subset of tickets indicating that each ticket in the first subset is a winner of an instant prize of known value.

14. The method of claim 11 wherein, upon receiving an indication of the submission of the unique code, the computer system applies the certain value of bonus points and retrieves the bonus game without receiving any further input from a player.

15. A system for use by lottery game players, the system comprising:
a set of physical game tickets for playing a first game, wherein each physical game ticket of the set of physical game tickets includes a substrate having printed thereon, in one or more areas, game play information for the first game, and a bonus indicator indicating eligibility for one or more instant bonus points and eligibility for one or more bonus games;
a web site, associated with the set of physical game tickets, configured to present at least one bonus game associated with the set of physical game tickets; and
a programmed computer system, the programmed computer system including at least one non-transitory computer-readable storage medium, having instructions stored thereon, executable by at least one processor, the instructions comprising:
a computer program configured to associate the one or more instant bonus points with a player account; and
a computer program configured to store and retrieve at least one bonus game, determine an outcome associated with the at least one bonus game, present the at least one bonus game to one or more players of the lottery game, wherein the at least one bonus game provides the one or more players with an opportunity to earn one or more additional bonus points according to the determined outcome, and apply the one or more additional bonus points to the player account.

16. The system of claim 15 wherein the one or more additional points have a minimum value that is associated with a known prize.

17. The system of claim 15 wherein a first subset of the game tickets indicates an instant prize of known value.
